(19) United States
(12) Patent Application Publication
(10) Pub. No.: US 2017/0301233 A1
(43) Pub. Date: Oct. 19, 2017

(54) VEHICLE PRIORITIZATION SYSTEM

(71) Applicant: FORD GLOBAL TECHNOLOGIES, LLC, Dearborn, MI (US)

(72) Inventors: Dennis WITT, Chelmsford Essex (GB); David SKIPP, Brentwood Essex (GB)

(73) Assignee: FORD GLOBAL TECHNOLOGIES, LLC, Dearborn, MI (US)

(21) Appl. No.: 15/491,165

(22) Filed: Apr. 19, 2017

(30) Foreign Application Priority Data
Apr. 19, 2016 (GB) 1606835.5

(51) Int. Cl. G08G 1/087

(52) U.S. Cl. CPC G08G 1/087

(57) ABSTRACT

A vehicle prioritization system is provided. The system includes a central controller. The central controller is configured to receive one or more characteristics of one or more vehicles, and the central controller is also configured to assign a priority for each of the one or more vehicles according to the one or more characteristics of each of the one or more vehicles. Movement of each of the one or more vehicles having a higher priority is prioritized over vehicles having a lower priority.

### CROSS-REFERENCE TO RELATED APPLICATION

This application claims foreign priority benefits under 35 U.S.C. §119(a)-(d) to GB Application 1606835.5, filed Apr. 19, 2016, which is hereby incorporated by reference in its entirety.

### TECHNICAL FIELD

The present disclosure relates to a vehicle prioritization system and is particularly, although not exclusively, concerned with a vehicle prioritization system configured to control traffic within a road network according to one or more traffic management policies.

### BACKGROUND

The timings of phases of traffic signals, particularly in towns and cities, are often configured to minimize the amount of queueing at junctions during busy periods. A local authority may analyze the number of vehicles passing through a junction at different times of day, and may configure the traffic signals accordingly. Additionally or alternatively, traffic cameras may be installed at junctions. Traffic management operators may refer to images captured by the cameras, and may adjust the timings of traffic signals in response to an increase in traffic at a particular junction.

### SUMMARY

According to an aspect of the present disclosure, there is provided a vehicle prioritization system configured to prioritize movement of vehicles based on one or more characteristics of the vehicles, the characteristics being communicated by the vehicles to the system.

According to another aspect of the present disclosure, there is provided a vehicle prioritization system. The system is configured to receive one or more characteristics of one or more vehicles; and determine a priority for each of the vehicles according to the characteristics of each vehicle, wherein movement of vehicles having a higher priority is prioritized over vehicles having a lower priority.

The system may prioritize the vehicles by applying the characteristics to one or more policies. For example, the policies may aim to minimize emissions, such as CO₂, NOₓ, particulates or any other emissions (from the vehicle or power source that charged the vehicle), to minimize congestion, to maximize vehicle throughput, or any other policy.

The one or more policies may be arranged in a hierarchy of policies. If two or more vehicles have the same priority according to a first policy, then the priority of the vehicles may be determined according to a second policy. The second policy may be at a lower level in the hierarchy than the first policy.

The one or more policies may be arranged in a hierarchy of policies. Each of the policies in the hierarchy may have a weighting. The priorities of the vehicles may be determined by determining priorities for each of the vehicles according to two of more of the policies; weighting the determined priorities according to the weighting of the policy used to determine the priority; and combining the weighted priorities.

The system may be configured to communicate the priorities to the respective vehicles. The priorities may be communicated to a driver of the vehicle, e.g. via a display screen and/or audibly.

The system may be configured to control the operation of one or more traffic signals according to the priorities of the vehicles, e.g. in order to permit a vehicle having a higher priority to pass through a junction in preference to a vehicle having a lower priority.

The system may be configured to communicate with the vehicles to request that the characteristics of the vehicles be transmitted to the system.

The one or more policies applied by the system may be determined according to a time of day, e.g. throughout, and may be prioritized at times when it is known to be congested.

The one or more policies applied by the system may be determined according to one or more environmental conditions.

The system may comprise a plurality of vehicles communicating with one another, e.g. via Vehicle-to-Vehicle protocol communications. The vehicles may determine their priorities amongst themselves, e.g. without reference to central infrastructure. Additionally or alternatively, the system may comprise infrastructure with which the vehicles communicate, e.g. via Vehicle-to-Infrastructure protocol communications. The infrastructure may determine the priorities for the vehicles.

According to another aspect of the present disclosure, there is provided a vehicle comprising:

a memory configured to store one or more characteristics of the vehicle; and

a communication device configured to transmit one or more of the characteristics of the vehicle to a vehicle prioritization system.

The communication device may be further configured to receive a priority of the vehicle from the vehicle prioritization system.

The vehicle may be further configured to indicate a priority of the vehicle to an occupant of the vehicle, e.g. via a display screen and/or audibly.

The vehicle may be further configured to indicate to an occupant of the vehicle a priority of the vehicle relative to a further vehicle proximate to the vehicle.

The vehicle may be an autonomous or semi-autonomous vehicle. The vehicle may be configured to autonomously give right of way to a further vehicle having a higher priority.

The vehicle may be configured to receive priorities of one or more further vehicles located proximate to the vehicle. The priorities may be a relative priority, e.g. relative to a particular vehicle.

According to another aspect of the present disclosure, there is provided an infrastructure comprising a communication device. The communication device is configured to receive signals comprising one or more characteristics of a plurality of vehicles. The infrastructure is configured to:

determine priorities of the vehicles by referring the characteristics of the vehicle to one or more policies; and

prioritize the movement of vehicles having a higher priority over vehicles having a lower priority.

According to another aspect of the present disclosure, there is provided a method of prioritizing the movement of vehicles. The method includes receiving one or more characteristics of one or more vehicles, determining a priority for each of the vehicles according to the characteristics of each vehicle, and prioritizing the movement of vehicles having a higher priority over vehicles having a lower priority.

The method may carry out any of the features mentioned above in respect of the system, vehicle or infrastructure.

To avoid unnecessary duplication of effort and repetition of text in the specification, certain features are described in relation to only one or several aspects or embodiments of the disclosure. However, it is to be understood that, where it is technically possible, features described in relation to any aspect or embodiment of the disclosure may also be used with any other aspect or embodiment of the disclosure.

For a better understanding of the present disclosure, and to show more clearly how it may be carried into effect, reference will now be made, by way of example, to the accompanying drawings, in the drawings:

### BRIEF DESCRIPTION OF THE DRAWINGS

FIG. 1 is a schematic view of a vehicle prioritization system according to arrangements of the present disclosure;

FIG. 2 is a schematic view of a signal controlled road junction within the vehicle prioritization system according to arrangements of the present disclosure;

FIG. 3 is a schematic view of a road junction within the vehicle prioritization system according to arrangements of the present disclosure;

FIG. 4 is a schematic view of a vehicle according to arrangements of the present disclosure; and

FIG. 5 is a schematic view of a vehicle prioritization system according to an alternative arrangement of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As described above, within previously proposed traffic management systems, the timings of traffic signals at a junction may be controlled in order to minimize the length of a queue of vehicles forming at a junction. Such system may be desirable in busy periods when it may be desirable to maximize the throughput of vehicles travelling through a road network.

However, in some circumstances, for example at times of day when the road network is less busy, it may be desirable to configure the traffic signals to control the flow of traffic according to other traffic management policies. For example, it may be desirable to control the flow of traffic to minimize the overall production of emissions, such as carbon dioxide (CO₂), nitrous oxides (NO_{X}) or any other vehicles emissions, produced within the road network. Alternatively, it may be desirable to control the flow of traffic to promote a policy of car sharing, or use of low emissions vehicles, such as electric vehicles.

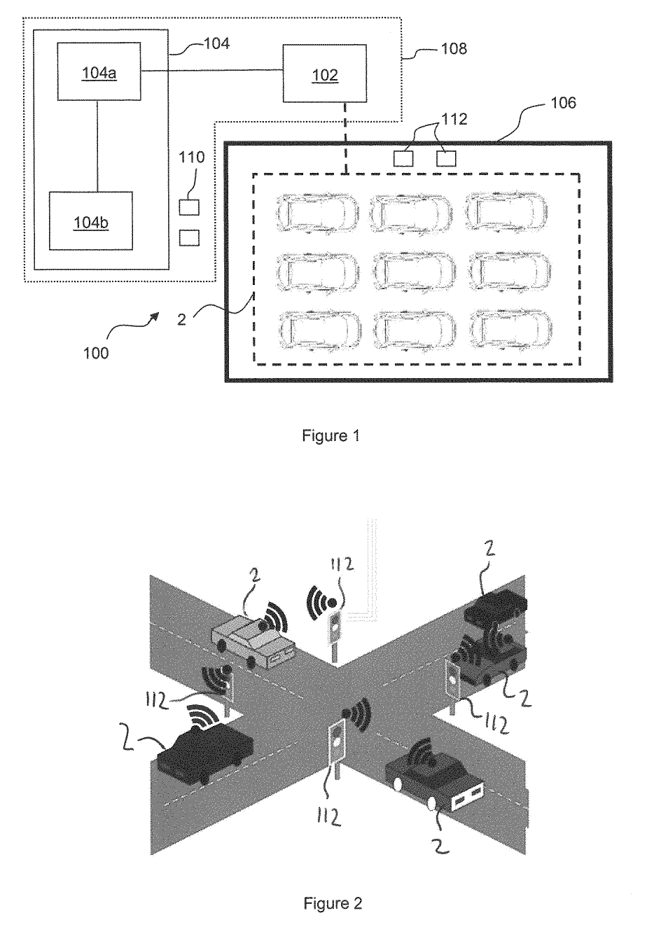

With reference to FIG. 1, in order to control the flow of traffic through a road network 106, according to one or more different traffic management policies, a vehicle prioritization system 100, according to arrangements of the present disclosure may be provided.

As depicted in FIG. 1, the system 100 may comprise a plurality of vehicles 2 operating within the road network 106. The system 100 may further comprise an infrastructure 108, the infrastructure 108 may comprise a communication device 102, a central controller 104, and one or more traffic sensors 110. The road network 106 covered by the system 100 may be any sized road network 106, for example, the road network 106 may comprise a single road junction, or the road network 106 may comprise a plurality of junctions, and roads forming a town, city or national road network.

The communication device 102 may be configured to communicate with the plurality of vehicles 2 operating within the system 100. As depicted in FIG. 1, the communication device 102 may communicate, e.g. directly communicate, with each vehicle of the plurality of vehicles 2 within the system.

In some arrangements of the disclosure, the system 100 may comprise a plurality of communication devices 102 provided within the infrastructure 108. The plurality of communication devices 102 may be distributed over the road network 106. The vehicles 2, may communicate with the communication devices 102 using a wireless communication method, such as a Dedicated Short-Range Communication (DSRC) method. In other arrangements, the vehicles 2 may communicate with the communication device 102 of the system 100 using a cellular communication system.

The infrastructure 108 may receive information from each of the vehicles 2 relating to characteristics of each vehicle 2. For example, the vehicles 2 may send information specifying a vehicle age, mass, size (e.g. height and/or width), terrain capability, maximum longitudinal acceleration, powertrain type (e.g. plug in hybrid, battery powered electric vehicle etc), state of charge of batteries of the vehicle (or remaining range of the vehicle), emissions category of the vehicle, vehicle occupancy, or any other characteristic of the vehicle. The system 100 may apply the information relating to vehicle characteristics to a traffic management policy, as described below, in order to determine priorities of each of the vehicles 2.

The infrastructure 108 may send a request to each of the vehicles 2 to transmit the characteristics of each of the vehicles 2 to the communication device 102. Alternatively, the vehicles 2 may send the characteristics to the system automatically when entering an area covered by the system 100, e.g. when entering a city center area or approaching a particular junction. When sending characteristics to the system 100, the vehicles 2 may supply each of their characteristics to the infrastructure 108, alternatively, the vehicles 2 may send the characteristics that are relevant to the traffic management policy currently being enacted by the system 100.

The communication device 102 may send characteristics received from the vehicles 2 to the central controller 104. The central controller 104 may comprise a processor 104a and a memory 104b. The memory 104b may comprise information defining the traffic management policy being enacted by the system 100. The processor 104a may apply the characteristics of each of the vehicles 2 to the policy in order to determine priorities of each of the vehicles 2. The priorities may be defined such that the movement of vehicles 2 having a higher priority may be prioritized over vehicles having a lower priority in order for the policy to be enacted. For example, if the policy is to limit the production of emissions, e.g. CO₂ or NO_{X}, within the system 100, older vehicles 2, vehicles 2 without hybrid or electric powertrains, and/or vehicles with a higher emissions category may be given a higher priority, such that the vehicles 2 are able to move more quickly through the system 100, minimizing the amount of emissions generated within the system 100. Alternatively, if the policy is to promote the use of electric vehicles 2, vehicles 2 having an electric powertrain may be given a higher priority. Alternatively, if the policy is to promote vehicle sharing, vehicles 2 having a higher occupancy may be given a higher priority than vehicles 2 having a lower occupancy. Alternatively, any other traffic management policy may be applied to determine the priorities of the vehicles 2.

The memory 104b of the central controller 104 may comprise information defining more than one traffic management policies to be applied within the system 100. The policies may be arranged in a hierarchy of policies, and the processor 104a may apply the policies in order. For example, the processor 104a may initially apply the characteristics of each of the vehicles 2 to the highest policy in the hierarchy. If two of more vehicles 2 have the same priority according to the highest policy on the hierarchy, the processor 104a may apply the characteristics of the two or more vehicles 2 to the next policy in the hierarchy. The processor 104a may continue applying the characteristics of the vehicles 2 to policies on lower levels of the hierarchy until a different priority has been determined for each of the vehicles 2 or until each of the policies within the hierarchy has been considered.

In an alternative arrangement, each of the policies in the hierarchy may be given a weighting, the priorities of the vehicles 2 may be determined by applying the characteristics of the vehicles 2 to two or more policies. The determined priorities may be weighted according to the weighting of the policy used to determine the priority. The weighted priorities for each of the vehicles 2 may be combined in order to determine an overall priority of each of the vehicles 2.

In other alternative arrangements, combinations of the above-described methods for determining priorities may be applied. For example, if the overall priority of two or more vehicles 2, determined using two or more weighted priorities, is the same, the processor 104a may determine a further weighted priority for the two or more vehicles, and combine the further weighted priority with the overall priority to determine a new overall priority.

The order of the policies within the hierarchy may be predetermined. The order of the priorities may be reordered or redefined as desired, e.g. by local or national authorities, in order to control a flow of traffic with the system 100 and/or promote low emissions vehicles 2, car sharing and/or any other incentive. In some arrangements, the system 100 may be configured to change the policies within the memory 104b, and/or the order of the policies within the hierarchy of policies.

The system 100 may adjust the policies according to the time of day. For example, during times of day when the roads are expected to be most busy, the system 100 may adjust the policies, e.g. the policies that are applied by the system, to maximize the throughput of vehicles through the traffic system. At other times of day, when the roads are expected to be less busy, the system 100 may adjust the policies to minimize emissions, encourage car sharing, or apply any other desirable traffic management policy.

Additionally or alternatively, the system 100 may refer to one or more traffic sensors 110 provided within the system 100, and may adjust the policies and/or the order of the policies within the hierarchy according to information provided by the traffic sensors 110. The traffic sensors may comprise traffic cameras configured to determine the number of vehicles 2 travelling within the system 100. Additionally or alternatively, the traffic sensors 110 may comprise environmental sensors configured to determine environmental data, such as the concentration of emissions, at a particular point in the system, e.g. a junction. In some arrangements, the system 100 may monitor the level of emissions, such as CO₂ or NO_{X}, via the traffic sensors 110, at a junction, and may adjust the policies according to the environmental data. For example, if it is determined that a concentration of NO_{X} at or close to a junction is above a threshold value, the system 100 may adjust the policies to apply a policy of minimizing NO_{X} production at the junction and/or within the system 100.

As depicted in FIG. 1, the traffic sensors 110 may be provided within the infrastructure 108. However, in some arrangements, the traffic sensors 110 may be provided on the vehicles 2.

The infrastructure 108 may communicate the determined priority, or overall priority to each of the vehicles 2. Additionally or alternatively, the system 100 may communicate the determined priorities to one or more traffic signals 112 provided within the road network 106.

With reference to FIG. 2, the system 100 may control the operation of one or more traffic signals 112 according to the priorities of the vehicles 2 approaching each of the traffic signals 112. The system 100 may control the operation of the traffic signals 112 provided at a junction in order to prioritize the movement of vehicles 2 having a higher priority over vehicles 2 having a lower priority. For example, when a high priority vehicle 2 approaches the junction, the system 100 may control the traffic signals 112 such that the traffic signal 112 arranged to control the movement of the high priority vehicle 2 indicates that the high priority vehicle 2 may continue through the junction. The other traffic signals 112, e.g. controlling other, lower priority vehicles 2 approaching the junction may be controlled by the system 100 to indicate that the further vehicles 2 may not continue through the junction at that moment.

In many arrangements, when the system 100 controls the operation of the traffic signals 112 to adjust the timing of the phases of the signals 112, it is likely that a group of vehicles 2 will pass through the junction. Hence, the system 100 may consider an average or aggregate priority for the group of vehicles 2 likely to pass through the junction, and may control the operation of the traffic signals 112 in order to allow the group of vehicles 2 with the highest average or aggregate priority to pass through the junction.

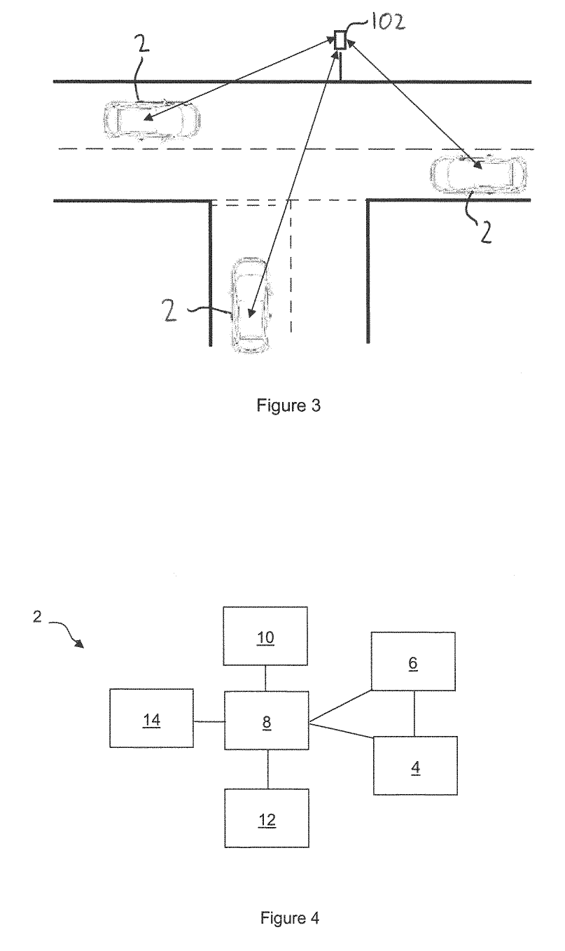

When a junction is controlled by traffic signals 112, for example as shown in FIG. 2, the system 100 may be able to directly control the flow of traffic through the junction by controlling the operation of the traffic signals 112. However, it may also be desirable to control or influence the flow of traffic through junctions that are not controlled by traffic signals 112, such as the T-junction depicted in FIG. 3.

In the arrangement shown in FIG. 3, vehicles 2 passing directly through the junction, e.g. not performing a turn maneuver, have right of way over vehicles 2 performing a turn maneuver at the junction. However, in some situations, a vehicle 2 attempting to make a turn maneuver may have a higher priority than a lower priority vehicle 2 travelling directly through the junction. In this case, the infrastructure 108 may communicate to the lower priority vehicle 2 that the vehicles 2 attempting to make a turn maneuver has a higher priority.

In some arrangements, the lower priority vehicle 2 may be an autonomous or semi-autonomous vehicle. When the lower priority vehicle 2 receives the communication indicating that it has lower priority than another vehicle 2 at the junction, the vehicle 2 may be controlled, e.g. autonomously controlled, to give right of way to the vehicle 2 with higher priority. The lower priority vehicle 2 may communicate to the vehicle 2 with higher priority that it is giving right of way to the higher priority vehicle 2. For example, the vehicles 2 may communicate using a Vehicle to Vehicle (V2V) communication system provided on each of the vehicles 2.

In other arrangements, the lower priority vehicle 2 may not be autonomous, or, stated differently, may not be currently controlled autonomously. The lower priority vehicle 2 may comprise a priority indicator configured to indicate the priority of the vehicle 2 to an occupant (not shown) of the vehicle 2, e.g. a driver. The driver may control the vehicle 2 to give right of way to the vehicle 2 with the higher priority.

In the arrangements shown in FIGS. 2 and 3, the vehicles 2 may communicate with the vehicle prioritization system 100 as they approach the junction, and may communicate their characteristics to the infrastructure 108. As depicted in FIG. 3, the vehicles 2 may communicate with a communication device 102 of the system provided at or close to the junction. In some arrangements, for example as shown in FIG. 2, the communication devices 102 may be provided on the traffic signals 112.

The vehicles 2 may communicate with the communication device 108 using any desirable Vehicle to Infrastructure communication method. For example, the vehicles 2 may communicate with the infrastructure 108 using DSRC, Wi-fi®, a cellular communication system or any other desirable wireless communication method.

With reference to FIG. 4, the vehicle 2 according to arrangements of the present disclosure may comprise a characteristic memory 4 configured to store one or more characteristics of the vehicle 2. The vehicle 2 may comprise a communication module 6 configured to transmit the characteristics of the vehicle 2 to the infrastructure 108 and/or other vehicles 2.

The communication module 6 may optionally be configured to receive priority information from the infrastructure 108. The communication module 6 may also be configured to optionally receive characteristics of other vehicles 2. The vehicle 2 may further comprise a processor 8 and policy memory 10 configured to store prioritization policies. Policies may be stored within the policy memory 10 in a hierarchy of policies. The processor 8 may be configured to determine priorities of the vehicle 2 or of other vehicles 2 by applying the characteristics of the vehicles 2 to the policies in the same way as described above with reference to the processor 104a.

The vehicle 2 may further comprise an indicator 14. The processor 8 may be configured to provide an indication to an occupant of the vehicle 2 indicating the priority of the vehicle 2. Additionally or alternatively, the processor 8 may indicate, to the occupant, the priorities of other vehicles 2 proximate to the vehicles 2, and/or may indicate the relative priorities of the vehicles 2. The indicator 14 may thereby indicate whether a driver of the vehicle 2 should give way to another vehicle 2.

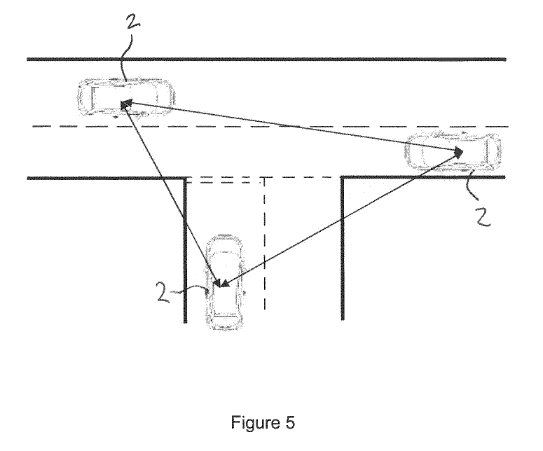

With reference to FIG. 5, in an alternative arrangement of the present disclosure, each of the vehicles 2, may be configured to communicate with each of the other vehicles 2 located in proximity to the vehicle 2. The vehicles 2 may be configured to communication their characteristics to each of the other vehicles 2, e.g. using V2V communication. Each of the vehicles 2 may be configured to determine their priority, and/or the priority of each of the other vehicles 2 in proximity to the vehicle 2. Each of the vehicles 2 may communicate its priority to the other of the vehicles 2. Each of the vehicles 2 may be configured to indicate the priority of the vehicle 2 to an occupant of the vehicle 2, e.g. the driver. In this way, the movement of the vehicle 2 through a junction or traffic system may be controlled, according to the priorities of the vehicles 2 in the same way as described above. In other words, the system 100 may consist of the plurality of vehicles 2, e.g. without the infrastructure 108.

As described above, the vehicle 2 may be an autonomous or semi-autonomous vehicle 2. The vehicle 2 may comprise a controller 12 configured to autonomously control the operation of the vehicle 2. The processor 8 may be configured to provide priority information to the controller 12 to enable to controller 12 to control the operation of the vehicle 2 in accordance with the priority of the vehicle 2 relative to others of the vehicles 2 on the road.

In addition to or as an alternative to using the characteristics of the vehicles 2 to prioritize the movement of vehicles 2 through the system 100, the system 100 may apply the characteristics of the vehicles 2 for other purposes.

In one arrangement, the system 100 may operate over a road network 106 in which tolls are charged. The tolls may be changed based on characteristics of the vehicle 2, such as the size, occupancy, efficiency rating or any other characteristic. In this arrangement, the system 100 may apply the characteristics of the vehicle 2 sent to the system 100 to determine the toll to be paid.

In other arrangements, the system 100 may operate over road networks 106 that are only accessible to vehicles 2 with a certain terrain capability. In this arrangement, the system 100 may determine the terrain capability of the vehicle 2 based on the characteristics of the vehicle 2 sent to the system 100. The system 100 may communicate with the vehicle 2 of a traffic signal 112 ahead of the vehicle 2 to indicate that the vehicle 2 is not capable of, or is prohibited from, travelling along the road network 106.

It will be appreciated by those skilled in the art that although the disclosure has been described by way of example, with reference to one or more exemplary examples, it is not limited to the disclosed examples and that alternative examples could be constructed without departing from the scope of the disclosure as defined by the appended claims.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle prioritization system comprising:
a central controller being configured to
receive one or more characteristics of one or more vehicles; and
assign a priority for each of the one or more vehicles based on the one or more characteristics of each of the one or more vehicles, wherein movement of each of the one or more vehicles assigned a higher priority is prioritized over each of the one or more vehicles assigned a lower priority.

2. The system of claim 1, wherein the central controller is further configured to apply the one or more characteristics to one or more policies to prioritize each of the one or more vehicles.

3. The system of claim 2, wherein the central controller is further configured to arrange the one or more policies in a hierarchy of policies such that in response to two or more of the one or more vehicles having a priority being the same according to a first policy, assign a priority of each of the one or more vehicles according to a second policy, wherein the second policy is at a lower level in the hierarchy of policies than the first policy.

4. The system of claim 2, wherein the one or more policies are arranged in a hierarchy of policies, and wherein each of the one or more policies in the hierarchy of policies has a weighting.

5. The system of claim 4, wherein the central controller assigns
the priority of each of the one or more vehicles based on two or more of the policies within the hierarchy of policies,
the weighting of the two or more policies, and
a combination of the weighting of the two or more policies.

6. The system of claim 1, wherein the central controller is further configured to communicate the priority of each of the one or more vehicles to each of a respective vehicle.

7. The system of claim 1, wherein the central controller is further configured to control an operation of one or more traffic signals based on the priority of each of the one or more vehicles.

8. The system of claim 1, wherein the central controller is further configured to communicate with each of the one or more vehicles to request transmission of the one or more characteristics of each of the one or more vehicles.

9. The system of claim 2, wherein the central controller arranges the one or more policies according to a time of day.

10. The system of claim 2, wherein the central controller arranges the one or more policies according to one or more environmental conditions.

11. A vehicle comprising:
a memory configured to store one or more vehicle characteristics; and
a communication device configured to transmit the one or more vehicle characteristics to a central controller of a vehicle prioritization system.

12. The vehicle of claim 11, wherein the communication device is further configured to receive a vehicle priority from the central controller of the vehicle prioritisation system.

13. The vehicle of claim 12, wherein the communication device is further configured to indicate the vehicle priority to an occupant.

14. The vehicle of claim 13, wherein the communication device is further configured to indicate to the occupant a relative priority being relative to a proximate vehicle.

15. The vehicle of claim 12, wherein the communication device is further configured to autonomously give a right of way to a higher priority vehicle.

16. The vehicle of claim 11, wherein the communication device is further configured to receive priorities of one or more proximate vehicles.

17. An infrastructure comprising:
a communication device configured to receive signals of one or more characteristics of a plurality of vehicles; and
a central controller configured to,
assign vehicle priorities by referring the one or more characteristics of the plurality of vehicles to one or more policies, and
prioritize movement of each vehicle of the plurality of vehicles having a higher priority over each vehicle of the plurality of vehicles having a lower priority.
